(19) United States
(12) Patent Application Publication
(10) Pub. No.: US 2010/0136246 A1
(43) Pub. Date: Jun. 3, 2010

(54) METHOD FOR PRODUCING SURFACES AND SUBSTRATES HAVING SAID SURFACES SO FORMED

(76) Inventors: JasPal Singh Badyal, Durham (GB); Lee Harris, Durham (GB); Wayne Schofield, Durham (GB)

Correspondence Address: CLARK & ELBING LLP, 101 FEDERAL STREET, BOSTON, MA, 02110, US

(21) Appl. No.: 12/446,851

(22) PCT Filed: Oct. 24, 2007
(86) PCT No.: PCT/GB07/04064

§ 371 Date: Dec. 30, 2009

(51) Int. Cl. B05D 1/02; H05H 1/24

(52) U.S. Cl. 427/447; 427/569

(57) ABSTRACT

This invention relates to a method, and products thereof, for producing amine and/or thiol functionalised surfaces using plasma deposition and the subsequent derivatization of said functionalised surfaces using biomolecules.

The present invention relates to the production of surfaces utilising the plasma polymerisation of compounds and their subsequent derivatisation.

Although the derivatisation referred to in the introduction is almost exclusively carbohydrate based it will be appreciated by those skilled in the art that the invention is equally applicable to other types of compounds which can be immobilised through Schiff-base and/or thiol chemistries.

The surface functionalisation of solid objects is a topic of considerable technological importance, since it offers a cost effective means of improving substrate performance without affecting the overall bulk properties. For instance, the attachment of biomolecules such as carbohydrates, DNA or proteins is of great technical interest, allowing the construction of biological arrays that are finding application in fields of study as diverse as computing (Aldeman, M. Science 1994, 266, 1021; Frutos, A. G. et al., Nuc. Acids Res. 1997, 25, 4748), drug discovery (Debouck, C. et al., Nature Genet. 1999, 1(suppl.) 48), cancer research (Van't Veer, L. J. et al. Nature 2002, 415, 530) and the elucidation of the human genome (McGlennen, R. C. Clinical Chemistry 2001, 47, 393).

The affinity of biomolecules, or other molecules of interest, for amine and/or thiol functionalised surfaces may also be utilised in applications involving purification, wicking, and emanation or venting. For example, amine functionalised porous media can be used in a number of fields involving fluid transfer, filtration, and chemical separation phenomena, in industries that include aerospace and defence; chemical processing; environmental control; power generation; oil and gas; air and water; food and beverage; healthcare and pharmaceuticals. The stringent standards of the latter industries are of particular interest and their requirements for means of extracting desirable bio-active molecules from mixtures may be met using sintered, porous polymer media functionalised with amine groups.

Furthermore, an amine and/or thiol surface offers a chemically versatile substrate that allows subsequent surface modification by the application of widely used solution-based chemistries including, but not limited to, acylation, alkylation reduction, atomic transfer radical polymerization, Cope elimination, Curtis re-arrangement, electroless deposition, Gabriel synthesis, Hinsberg testing, Hofmann elimination, Hofmann re-arrangements, nitrosation, nucleophilic attack, oxidation phase transfer agents, quaternisation, heavy metal complexation (eg. Pd²⁺ species) and reductive amination.

Previous methods of producing thiol functionalised surfaces have been successful previously (PCT/GB2006/001051). However, their successful derivatisation has always been difficult and it is only with the current developments with amine functionalised surfaces that a solution to the problem of derivatisation has presented itself.

Existing methods of functionalising solid surfaces with amine groups include amine self-assembly (Ritchie, J. E. et al J. Am. Chem. Soc 1998, 120, 12), amine silanization (Mizukami, M. Colloid and Polymer Science 2005, 106, 266), immobilization of polyamido dendrimers (Kim, Y. P. et al Applied Surface Science, 2006, 252, 6801) and UV graft polymeriation of 4-vinylaniline (Ji, L. Y. et al. Reactive and Functional polymers, 2000, 46, 145). All of these approaches suffer from drawbacks such as involving multistep processes, substrate specificity, and the requirement for solution phase chemistry.

Surface functionalisation by continuous wave plasma polymerisation is an additional route by which amines have been attached to solid surfaces. This approach generally suffers from the drawback of poor structural retention, with surfaces showing increased oxygenation and/or a loss of amine functionality compared to their monomer precursors (Bae, B. et al Polymer, 2001, 42, 7879; Paterno, L. G. et al. Synthetic metals, 2002, 130, 85)

Plasma polymers are hence often regarded as being structurally dissimilar to conventional polymers, since they possess high levels of cross-linking and lack a regular repeat unit (Yasuda, H. Plasma Polymerisation Academic Press: New York, 1985). This can be attributed to the plasma environment generating a whole range of reactive intermediates that contribute to the overall lack of chemical selectivity. However, it has been found that pulsing the electric discharge on the ms-μs timescale can significantly improve structural retention of the parent monomer species (Panchalingam, V. et al., Appl. Polym. Sci. 1994, 54, 123; Han, L. M. et al., Chem. Mater., 1998, 10, 1422; Timmons et al., U.S. Pat. No. 5,876,753) and in some cases conventional linear polymers have been synthesised (Han, L. M. et al., J. Polym. Sci., Part A: Polym. Chem. 1998, 36, 3121). Under such conditions, repetitive short bursts of plasma are understood to control the number and lifetime of active species created during the on-period, which then is followed by conventional reaction pathways (e.g. polymerisation) occurring during the off-period (Savage, C. R. et al., Chem. Mater., 1991, 3, 575).

The preparation of amine functionalised surfaces by pulsed plasma polymerisation has previously been reported using aniline and allyamine (Tamirisa, P. A. et al, J. Appl. Polym. Sci. 2004, 93, 1317). However, the retention of monomer structure was poor and produced non-uniform coated surfaces that exhibited low levels of usable amine functionality. The observed inadequate level of sample performance was due to the structure of the monomer utilised.

Aniline lacks a functional group, such as an acrylate or alkene functionality, that can be readily polymerised by conventional reaction pathways during the pulsed plasma off-time without damage to the desired amine moiety. Plasma polymerisation even under mild pulsing conditions must necessarily proceed via the aryl group. This results in unavoidable rupture of the monomer structure and damage to the neighbouring amine functionality. Similarly, whilst allylamine possesses a readily polymerisable alkene functional group it is located in very close proximity to the amine group, separated by a single CH₂ moiety. Hence, plasma polymerisation even under mild pulsing conditions results in the unavoidable involvement of the desired amine functionality yielding films that display an unacceptable degree of cross-linking and loss/damage of the desired amine functionality.

It is therefore an aim of the present application to overcome the problems listed above.

According to the first aspect of the invention there is provided a method for applying a reactive amine containing layer to a substrate, said method comprising subjecting said substrate to a plasma discharge in the presence of a compound of general formula (I):

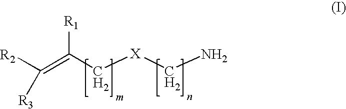

Where X is an optionally substituted straight or branched alkylene chain(s) or aryl group(s); R¹, R² or R³ are optionally substituted hydrocarbyl or heterocyclic groups; and m and n are integers of 0 or greater value.

As used herein, the term “hydrocarbyl” includes alkyl, alkenyl, alkynyl, aryl and aralkyl groups. The term “aryl” refers to aromatic cyclic groups such as phenyl or naphthyl, in particular phenyl. The term “alkyl” refers to straight or branched chains of carbon atoms, suitably of from 1 to 20 carbon atoms in length. The terms “alkenyl” and “alkynyl” refer to straight or branched unsaturated chains suitably having from 2 to 20 carbon atoms. These groups may have one or more multiple bonds. Thus examples of alkenyl groups include allenyl and dienyl.

Typically, substituents for hydrocarbyl groups R¹, R², R³ and alkylene/aryl groups X are groups that are substantially inert during the process of the invention. They may include halo groups such as fluoro, chloro, bromo and iodo. Particularly preferred halo substituents are fluoro.

In preferred embodiments of the invention, X is an aromatic group(s) including but not limited to benzene, naphthalene and anthracene; R¹, R² or R³ are optionally substituted hydrocarbyl or heterocyclic groups; and m/n are integers of 0 or higher value, most suitably from 0 to 20. More preferably, X is a di-substituted benzene ring and both m and n are zero, such as vinylbenzenes of formula (II):

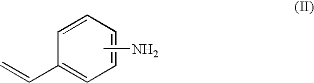

where the ring can be ortho, meta or para substituted.

In a favoured embodiment compound of formula (II) is 4-vinylaniline.

In one embodiment of the invention, X is a moiety comprising an ester group adjacent to an optionally substituted hydrocarbyl or heterocyclic group. Typically, such compounds combine the desired amine functionality with a highly polymerisable acrylate-like group (e.g. acrylate, methacrylate).

Precise conditions under which the plasma deposition of the compound of formula (I) takes place in an effective manner will vary depending upon factors such as the nature of the monomer, the substrate, the size and architecture of the plasma deposition chamber etc. and will be determined using routine methods and/or the techniques illustrated hereinafter. Typically, polymerisation is suitably effected using vapours or atomised droplets of compounds of formula (I) at pressures of from 0.01 to 999 mbar, preferably at about 0.2 mbar.

In one embodiment atmospheric-pressure plasmas are utilised for plasma polymer deposition.

In one embodiment a glow discharge is ignited by applying a high frequency voltage, typically at 13.56 MHz. The applied fields are typically of an average power of up to 50 W.

The fields are applied for a period sufficient to give the desired layer. In general, this will be from 30 seconds to 60 minutes, preferably from 1 to 15 minutes, depending upon the nature of the compound of formula (I) and the substrate etc.

Typically, the average power of the plasma discharge is low, for example of less than 0.05 W/cm³, preferably less than 0.025 W/cm³ and most preferably less than 0.0025 W/cm³. Such low average powers are most effectively applied by pulsing the plasma discharge.

The pulsing regime which will deliver such low average power discharges will vary depending upon the nature of the substrate, the size and nature of the discharge chamber and other parameters. However, suitable pulsing arrangements can be determined by routine methods in any particular case.

A typical sequence is one in which the power is on for from 10 μs to 100 μs, and off for from 1000 μs to 20000 μs.

In one embodiment of the invention the pulsing regime is varied during the course of layer deposition so as to enable the production of gradated layers. For example, a high average-power pulsing regime may be used at the start of sample treatment to yield a highly cross-linked, insoluble sub-surface layer that adheres well to the substrate. A low average-power pulsing regime may then be adopted for conclusion of the treatment cycle, yielding a surface layer displaying high levels of retained monomer amine functionality on top of said well-adhered sub-surface. Such a regime improves overall layer durability and adhesion, without sacrificing any of the desired surface properties (i.e. reactive surface amine/thiol functionality).

Typically, the plasmas used in the method of the invention include non-equilibrium plasmas such as those generated by audio-frequencies, radiofrequencies (RF) or microwave frequencies.

In another embodiment the plasma is generated by a hollow cathode device. In yet another embodiment, the pulsed plasma is produced by direct current (DC).

The plasma may operate at low, sub-atmospheric or atmospheric pressures as are known in the art. The monomer may be introduced into the plasma as a vapour or an atomised spray of liquid droplets (WO03101621 and WO03097245, Surface Innovations Limited).

In one embodiment the monomer is introduced into the pulsed plasma deposition apparatus continuously or in a pulsed manner by way of, for example, a gas pulsing valve

In one embodiment the substrate to which the amine bearing layer is applied will preferentially be located substantially inside the plasma during coating deposition. In an alternative embodiment, the substrate may be located outside of the plasma. Typically, this avoids excessive damage to the substrate or growing layer.

The monomer will typically be directly excited within the plasma discharge. However, in alternative embodiments “remote” plasma deposition methods may be used. In said methods the monomer enters the deposition apparatus substantially “downstream” of the pulsed plasma, thus reducing the potentially harmful effects of bombardment by short-lived, high-energy species such as ions.

In one embodiment the plasma may comprises the monomeric compound alone, in the absence of other compounds.

In an alternative embodiment the plasma comprises an admixture of monomeric compound with for example an inert gas.

Typically, plasmas consisting of monomeric compound alone may be achieved by first evacuating the reactor vessel as far as possible, and then purging the reactor vessel with the organic compound for a period sufficient to ensure that the vessel is substantially free of other gases. The temperature in the plasma chamber is suitably high enough to allow sufficient monomer in gaseous phase to enter the plasma chamber. This will depend upon the monomer and ambient temperature. However, elevated temperatures for example from 25 to 250° C. may be required in some cases.

In alternative embodiments of the invention, materials additional to the plasma polymer coating precursor are present within the plasma deposition apparatus. The additional materials may be introduced into the coating deposition apparatus continuously or in a pulsed manner by way of, for example, a gas pulsing valve.

Said additive materials may be inert and act as buffers without any of their atomic structure being incorporated into the growing plasma polymer (suitable examples include the noble gases). A buffer of this type may be necessary to maintain a required process pressure. Alternatively the inert buffer may be required to sustain the plasma discharge.

In one embodiment, the operation of atmospheric pressure glow discharge (APGD) plasmas requires large quantities of helium buffer. This helium diluent maintains the plasma by means of a Penning Ionisation mechanism without becoming incorporated within the deposited layer.

In other embodiments of the invention, the additive materials possess the capability to modify and/or be incorporated into the layer forming material and/or the resultant plasma deposited layer. Suitable examples include other reactive gases such as halogens, oxygen, and ammonia.

In alternative embodiments of the invention, the additive materials are other monomers. The resultant coatings comprise copolymers as are known and described in the art. Suitable monomers for use within the method of the invention include organic (e.g. styrene), inorganic, organo-silicon and organo-metallic monomers.

The invention further provides a substrate having an amine containing coating thereon, obtained by a process as described above. Typically, such substrates include any solid, particulate, permeable and/or porous substrate or finished article, consisting of any materials (or combination of materials) as are known in the art. Examples of materials include, but are not limited to, woven or non-woven fibres, natural fibres, synthetic fibres, metal, glass, ceramics, semiconductors, cellulosic materials, paper, wood, or polymers such as polytetrafluoroethylene, polyethylene or polystyrene.

In an embodiment, the surface comprises a support material, such as a polymeric material or glass, used in biochemical analysis. Examples include such substrates as are utilised in the bio-technological fields of genomics, proteomics, and glycomics

In another embodiment the substrate having an amine functionalised coating, obtained by a process as described above, is a porous media for use in applications that involve fluid transfer, filtration, and/or chemical separation phenomena. Examples of such purification, wicking, and emanation/venting applications abound in industries that include aerospace and defence; chemical processing; environmental control; power generation; oil and gas; air and water; food and beverage; healthcare and pharmaceuticals.

In a further embodiment of an article or substrate produced by the method of the invention, the amine functionalised surface is a sintered porous polymer media used for separating or extracting biologically active molecules of interest from mixtures. Such items are often utilised in the pharmaceutical, biomedical, and healthcare industries.

In one embodiment of the invention the substrate is coated continuously by means of a reel-to-reel apparatus. In one embodiment the substrate is moved past and through at least one coating apparatus acting in accordance with this invention.

The pulsed plasma polymerisation of the invention is therefore a solventless method for functionalising solid surfaces with amine groups.

Once the amine functional layer has been applied to the substrate, the amine group may be further derivatised, quaternised or complexed with additional reagents as required. In particular, it may be reacted with an aldehyde such as an aldehyde terminated oligonucleotide strand or a carbohydrate. The derivatisation reaction may be effected in the gaseous phase where the reagents allow, or in a solvent such as water or an organic solvent. Examples of such solvents include alcohols (such as methanol), and tetrahydrofuran.

In one embodiment the step of derivatization is used for quatarnization of the amine groups.

In one embodiment the step of derivatization is used for electroless metal deposition.

In one embodiment the step of derivatization is used for atom transfer radical polymerization. Typically, the step of derivatization or reaction of the amine groups is performed by reaction with a carbonyl group on the derivatizing substance.

The derivatisation may hence result in the immobilisation of an aldehyde containing reagent on said surface. If derivatisation is spatially addressed, this results in chemical patterning of the surface. A preferred case of an amine surface patterned with aldehyde containing biomolecules is a biological microarray. A particularly preferred case is one in which the aldehyde containing biomolecule is a carbohydrate, resulting in a carbohydrate microarray.

In one aspect of the invention there is provided a substrate with at least one amine containing layer thereon, said at least one layers produced by the method of producing one or more amine containing layers on a substrate, said method comprising of subjecting said substrate to a plasma discharge in the presence of at least one compound containing at least one amine functionality, and repeating said plasma discharge as required.

In one embodiment the at least one compound is 4-vinylaniline.

In one embodiment the one or more layers are polymer layers.

In one aspect of the invention there is provided a substrate with at least one amine containing layer thereon, said at least one layers produced by the method described above.

In one embodiment the derivatisation of the one or more amine containing layers occurs with at least one derivatising substance.

In one embodiment the at least one derivatising substances contain one or more carbonyl groups.

In one embodiment the at least one carbonyl group is an aldehyde.

In one embodiment the at least one derivatising substance is a carbonyl group containing biomolecule.

In one embodiment the derivatising substance is a carbonyl terminated carbohydrate.

In one embodiment the modified surface is utilised for DNA hybridisation.

In one aspect of the invention there is provided a method of producing a biomolecule modified surface, said method comprising the steps of:

i) producing one or more amine containing layers on a substrate by subjecting said substrate to a plasma discharge in the presence of at least one compound containing at least one amine functionality;
ii) repeating said plasma discharge as required; and
iii) exposing at least a portion of the one or more amine containing layers to a carbonyl containing biomolecule.

In one embodiment the biomolecule is a carbohydrate

In one embodiment the immobilised carbohydrate is utilised for glycomic applications.

In one aspect of the invention there is provided a carbohydrate surface produced by the method described above.

In one embodiment the immobilisation of the derivatising substance is spatially addressed onto the amine containing surface, such that immobilisation occurs only in given spatial locations.

In another aspect of the invention there is provided a method of producing a derivatised surface, said method comprising the steps of exposing at least part of a substrate to a plasma discharge in the presence of at least one first compound with general formula (I) and/or (III) and/or (IIIa) to produce a functionalised surface, and exposing the resulting functionalised surface to at least one second compound.

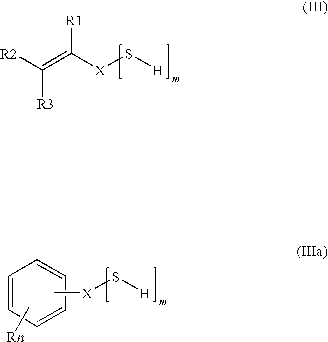

Where X is an optionally substituted straight or branched alkylene chain(s) or aryl group(s); R¹, R² or R³ are optionally substituted hydrocarbyl or heterocyclic groups, and m is an integer greater than 0; Rⁿ is a number of optionally substituted hydrocarbyl or heterocyclic groups, where n is 0-5.

Typically, the at least one second compounds are biomolecules such as carbohydrates, sugars, proteins, peptides, nucleic acids, lipids, oligonucleotides and/or the like. Preferably the derivatised surfaces are formed from Schiff-base imine formation reactions in the case of functionalised surfaces formed with general formula (I), and/or disulfide bridge formation reactions in the case of functionalised surfaces formed with compounds (III) and/or (IIIa)

In one embodiment amine functionalised surfaces produced from compounds of general structure (I) were derivatized with an aldehyde containing second compound. Typically, the aldehyde containing second compound is a biomolecule such as a carbohydrate.

In one embodiment the derivatized surfaces formed from disulfide bridge formation reactions in the case of functionalised surfaces formed with compounds (III) and/or (IIIa) are reversed to reproduce thiol containing layers.

In one embodiment the derivatized surfaces formed from a disulfide bridge formation reactions in the case of functionalised surfaces formed with compounds (III) and/or (IIIa) are reversed to reproduce thiol containing layers and subsequently rederivatized.

In one embodiment the thiol functionalised surfaces produced from compounds of general structure (III) and/or (IIIa) are derivatized with a methanethiosulfonate-containing second compound.

Preferably the methanethiosulfonate-containing second compound is a biomolecule.

In one embodiment the methanethiosulfonate-containing second compound is a carbohydrate sugar (glycomethanethiosulfonate).

In one embodiment the biomolecule compound is dispensed from a micro array means to form a biomolecule microarray.

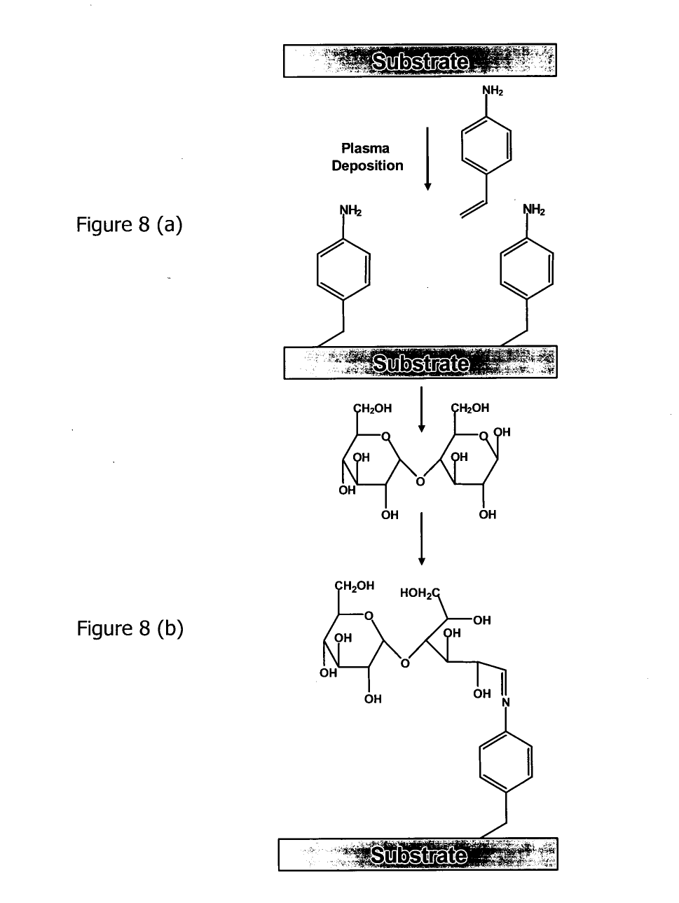

Preferably, these amine functionalised surfaces are then used to construct biomolecule microarrays by a procedure shown diagrammatically in FIG. 8.

In one embodiment the biomolecule microarrays are fabricated using a robotic microarrayer. Typically, the robotic microarrayer delivers the biomolecule, such as a carbohydrate, with 1 nL micro-machined pins.

In one embodiment thiol functionalised surfaces produced from compounds of general structure (III) and/or (IIIa) were derivatized with a methanethiosulfonate-containing second compound. Typically the methanethiosulfonate-containing second compound is a biomolecule such as carbohydrates, proteins, lipids and/or peptides. Preferably the methanethiosulfonate-containing biomolecule is a carbohydrate such as glycomethanethiosulfonate.

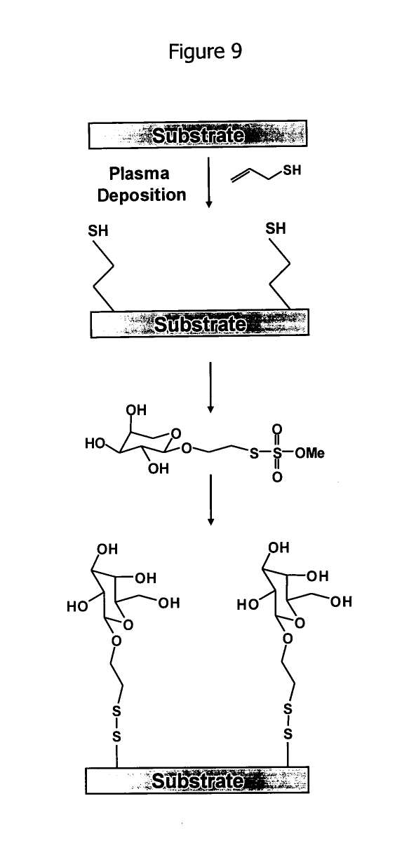

Typically, these functionalised surfaces are then used to construct carbohydrate microarrays by a procedure shown diagrammatically in FIG. 9.

Thus, the invention provides a method for the immobilisation of an amine and/or thiol containing reagent at a surface, said method comprising the application of a reactive amine and/or thiol containing layer to said surface by a method described above, and then contacting the surface with a solution of said aldehyde-containing and/or methanethiosulfonate-containing agent under conditions such that the aldehyde-containing agent and/or the methanethiosulfonate-containing agent reacts with the amine/thiol groups.

Pulsed plasma polymerization in accordance with the invention has hence been found to be an effective means for functionalizing solid substrates with amine/thiol groups. The resulting functionalised surfaces are amenable to conventional amine/thiol derivatization chemistries, such as those comprising the immobilisation of molecules containing aldehyde and/or glycomethanethiosulfonate groups.

In a third aspect of the invention there is provided a method of producing a multi-derivatised surface, said method comprising the steps of;
i) exposing at least part of a substrate to a plasma discharge in the presence of one first compound with general formula (I) or (III) or (IIIa) to produce a first functionalised layer;
ii) exposing said first functionalised layer to a plasma discharge in presence of one second compound, with general formula (I) or (III) or (IIIa) to produce an additional functionalised layer;
iii) repeating step (ii) as required;
iv) removal of at least a portion of the upper layers thereby exposing lower functionalised layers; and
v) exposing the resulting multi-functionalised layers to at least a third and fourth compounds to produce said multi-derivatised surface.

Typically, to produce the multi-derivatised surface, the third and/or fourth compounds are biomolecules containing methanethiosulfonate groups and/or aldehyde groups.

In one embodiment the removal of at least the upper layers is achieved by scratching away the same using a SPM tip. Typically, before the upper layers are scratched away a protein-resistant film is deposited. Preferably the film is a 20 nm thick poly(N-acryloylsarcosine methyl ester) film.

In an alternative embodiment, before or after the production of the first functionalised layer, a grid is embossed and subsequently removed following additional layer production to expose said lower functionalised layers.

In a further aspect of the invention there is a method of producing an array on a substrate, said method comprising the steps of:

i) depositing at least one amine and/or thiol containing layers on the substrate by exposing said substrate to one or more plasma discharges in the presence of amine and/or thiol containing compounds; and
ii) exposing said at least a portion of one or more amine and/or thiol containing layers to at least one reagent.

In one embodiment the at least one reagent is a biomolecule reagent.

In one embodiment a grid is embossed on said substrate before or after the deposition of the first layer, typically before exposure to the at least one biomolecule reagents.

In one embodiment at least a portion of one of more deposited layers is removed with a SPM tip before exposure to said at least one biomolecule reagents. Typically at least the uppermost layer is scratched away with the SPM tip to expose the one or more layers underneath, before exposing them to the biomolecule reagent.

The invention will now be particularly described by way of examples with reference to the accompanying drawings in which:

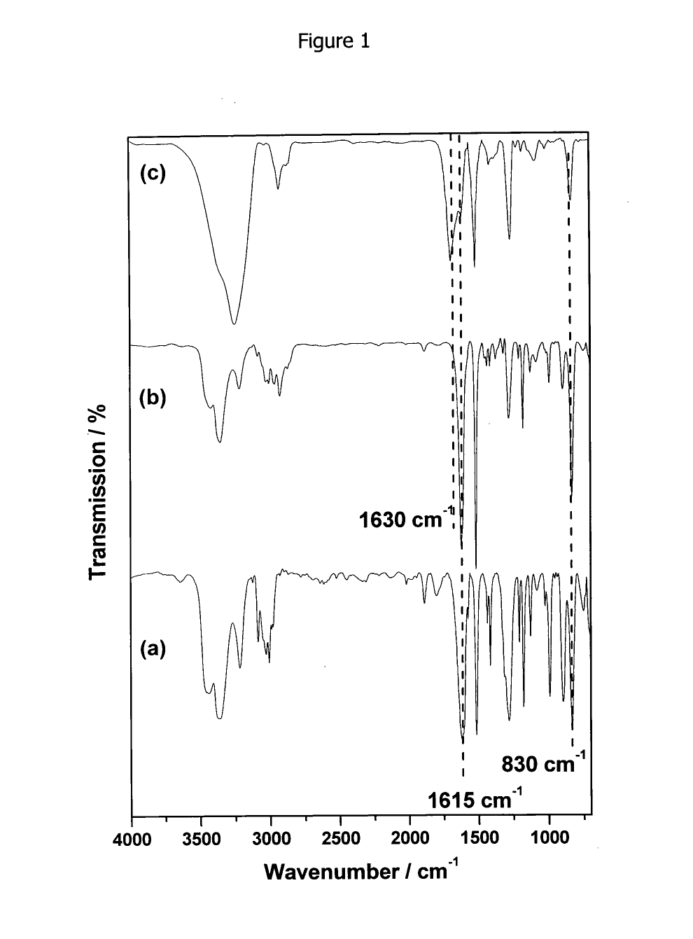

FIG. 1 shows the FT-IR spectra of: (a) 4-vinylaniline monomer; (b) 4-vinylaniline pulsed plasma polymer (tₒₙ=100 μs, t_{off}=4 ms); and (c) D-maltose immobilized onto pulsed plasma deposited poly(4-vinylaniline) deposited in accordance with one aspect of the invention.

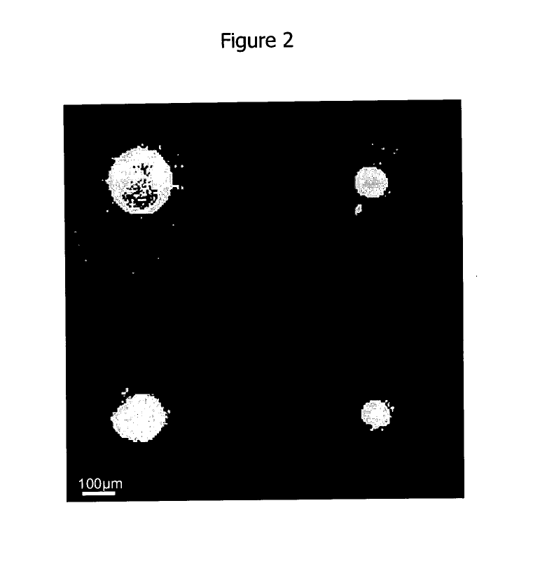

FIG. 2 Shows the D-maltose spots immobilized onto pulsed plasma deposited poly(4-vinylaniline), in accordance with one aspect of the invention, after exposure to Alexa Fluor 633 Concanavalin A examined by fluorescence microscopy.

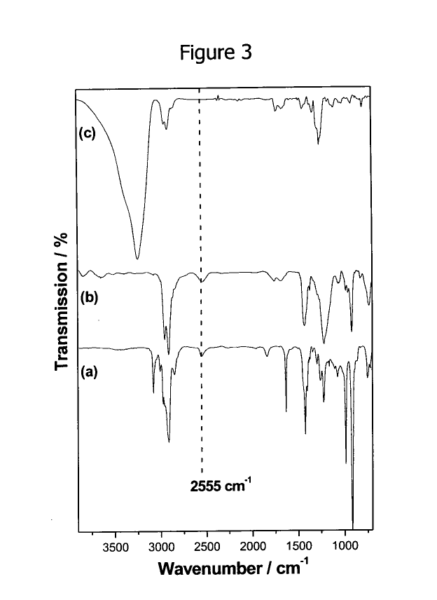

FIG. 3 shows the FT-IR spectra of: (a) allylmercaptan monomer; (b) pulsed plasma polymerized poly(allylmercaptan); and (c) β-D-galacto-methanethiosulfonate immobilized onto poly(allylmercaptan) according to one aspect of the invention

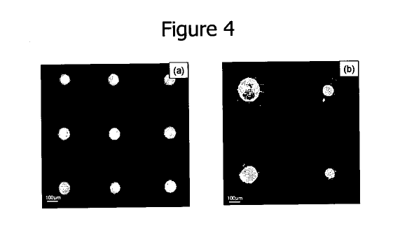

FIG. 4 shows Fluorescence images of: (a) β-D-galacto-methanethiosulfonate array following exposure to complementary fluorescent Protein I (galactose specific lectin protein PNA); and (b) D-maltose array after exposure to complementary fluorescent Protein II (maltose specific lectin Concanavalin A).

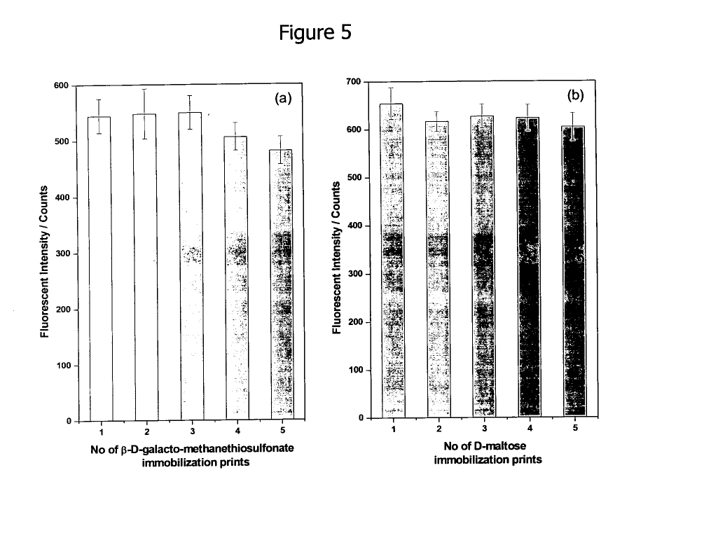

FIG. 5 shows Fluorescence intensity following stripping and re-immobilization of: (a) β-D-galacto-methanethiosulfonate and then exposure to Protein I (galactose specific lectin protein PNA); and (b) D-maltose and then exposure to Protein II (maltose specific lectin Concanavalin A). The fluorescence signal dropped to the background level for each fully stripped/denatured sample in between re-writing of the respective sugar Fluorescence intensity.

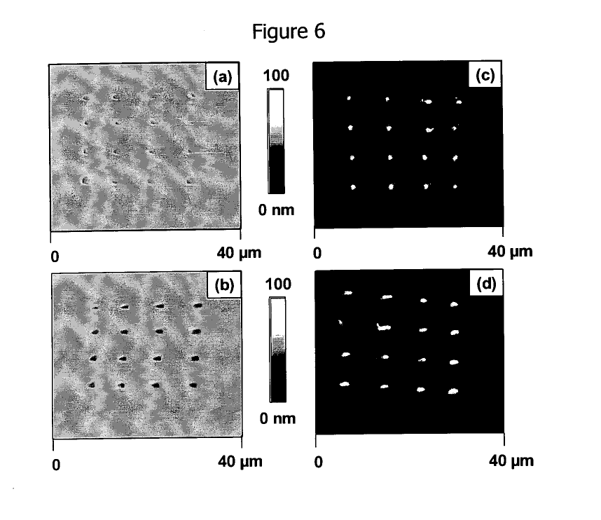

FIG. 6 shows AFM micrographs of a 4×4 array of exposed reactive pixels surrounded by a protein-resistant background wherein: (a) shows thiol functionalities; and (b) shows amine functionalities. The corresponding fluorescence images following: (c) immobilization of β-D-galacto-methanethiosulfonate and then exposure to Protein I; and (d) immobilization of D-maltose and then exposure to Protein II according to one embodiment of the invention.

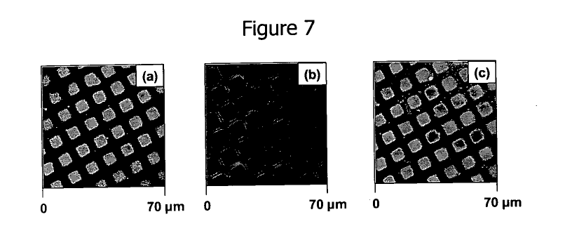

FIG. 7 shows Fluorescence microscopy for β-D-galacto-methanethiosulfonate functionalized poly(allylmercaptan) squares and D-maltose functionalized poly(4-vinyaniline) bars following exposure to: (a) Protein I; (b) Protein II; and (c) a mixture of Protein I and Protein II according to one embodiment of the invention.

FIG. 8 shows carbohydrate immobilization on surfaces according to an aspect of the invention wherein: (a) shows amine surface functionalisation by pulsed plasma polymerisation of 4-vinylaniline, (b) shows immobilisation of a carbohydrate via the aldehyde terminus present during mutarotation onto the pulsed plasma polymer surface by Schiff-base chemistry.

FIG. 9 shows β-D-galacto-methanethiosulfonate functionalization of pulsed plasma deposited poly(allylmercaptan) according to one aspect of the invention.

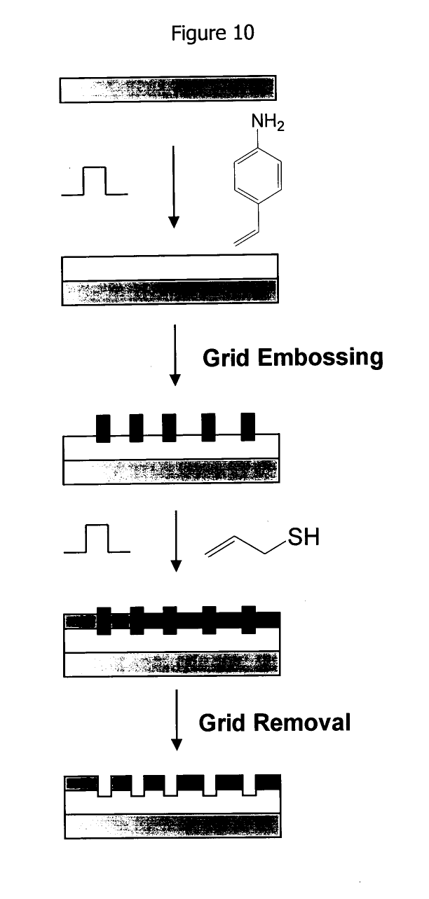

FIG. 10 shows formation of a patterned multi-functional surface via grid embossing for carbohydrate immobilization in accordance with one embodiment of the invention.

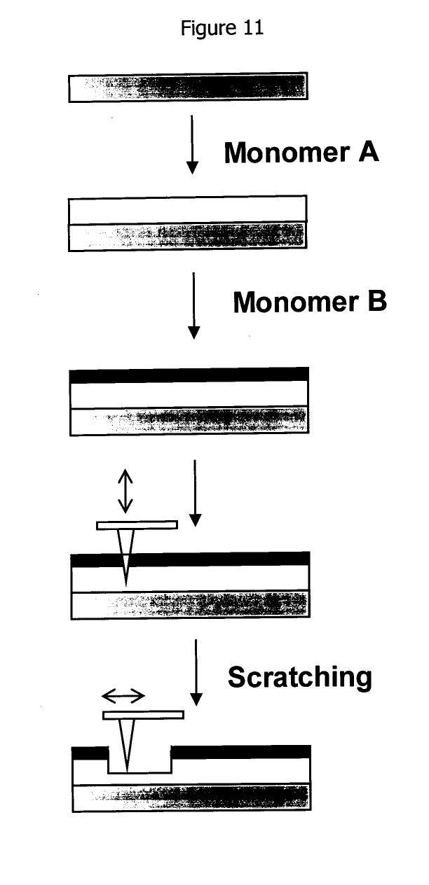

FIG. 11 shows molecular scratchcard fabrication followed by SPM tip scratching, where monomer A is sugar binding and monomer B is protein resistant according to an embodiment of the invention.

The following examples are intended to illustrate the present invention but is not intended to limit the same:

### EXAMPLE 1

Referring to FIGS. 1-3 plasma polymerization of 4-vinylaniline (Aldrich, 97%, H₂C═CHC₆H₄NH₂), purified by several freeze-pump-thaw cycles) was carried out in an electrodeless cylindrical glass reactor (5 cm diameter, 520 cm³ volume, base pressure 3×10⁻² mbar, leak rate=1×10⁻⁹ mol s⁻¹) enclosed in a Faraday Cage. The chamber was fitted with a gas inlet, a thermocouple pressure gauge and a 30 L min⁻¹ two-stage rotary pump connected to a liquid nitrogen cold trap. All joints were grease free. An externally wound 4 mm diameter copper coil spanned 8-15 cm from the gas inlet with 9 turns.

The output impedance of a 13.56 MHz RF power supply was matched to the partially ionized gas load with an L-C matching network. In the case of pulsed plasma deposition, the RF source was triggered from an external signal generator, and the pulse shape monitored with a cathode ray oscilloscope. The reactor was cleaned by scrubbing with detergent, rinsing in water, propan-2-ol and drying in an oven. The reactor was further cleaned with a 0.2 mbar air plasma operating at 40 W for a period of 30 min. Each substrate was sonically cleaned in a 50:50 mixture of cyclohexane and propan-2-ol for 10 min and then placed into the centre of the reactor on a flat glass plate.

Carbohydrate microarrays were fabricated using a robotic microarrayer (Genetix Inc) equipped with 1 nL delivery micro-machined pins. D-maltose solution (1 μm in Formamide (Sigma-Aldrich)) were spotted onto pulsed plasma poly(4-vinylaniline) coated glass slides (18×18×0.17 mm, BDH), Circular spots with diameters ranging from 100 to 125 μm could be routinely obtained. After spotting, the slides of immobilized carbohydrates were kept in a humidity chamber for 36 h at 70° C. respectively. The slides were subsequently washed with CHES buffer, CHES buffer diluted to 50% v/v with de-ionized water, and twice with de-ionized water.

The microarrays of D-maltose were then exposed to a complementary solution of Alexa Fluor 633 Concanavalin A (20 μg mL⁻¹ in phosphate buffered saline) for 60 min at room temperature followed by successive rinses in phosphate buffered saline, phosphate buffered saline diluted to 50% v/v with de-ionized water, and finally washed twice with de-ionized water.

A comparison of the infrared spectra obtained from 4-vinylaniline monomer and pulsed plasma deposited films shows the presence of asymmetric amine stretching (3440 cm⁻¹), symmetric amine stretching (3350 cm⁻¹), aromatic CH stretching (3090 cm⁻¹), ring summation (1880 cm⁻¹), C═C stretching (1625 cm⁻¹), NH₂ deformations (1615 cm⁻¹), para substituted aromatic ring stretching (1500 cm⁻¹), ═CH₂ deformations (1415 cm⁻¹), aromatic C—N stretching (1300 cm⁻¹), para substituted benzene ring stretching (1170 cm⁻¹), HC═CH trans wagging (990 cm⁻¹), ═CH₂ wagging (910 cm⁻¹) and NH₂ wagging (850 cm⁻¹) within the monomer, FIG. 1(a). All of the bands associated with the 4-vinylaniline monomer are clearly discernible following pulsed plasma polymerization, except for the carbon-carbon double bond features, which disappear during polymerization, FIG. 1(b). Further infrared studies of the pulsed plasma deposited poly(4-vinylaniline) upon exposure to D-maltose show the attenuation of the amine NH₂ wag (850 cm⁻¹), NH₂ deformation (1615 cm⁻¹) and the inclusion of a OH stretch (3250 cm⁻¹) and C═N stretch (1630 cm⁻¹) due to Schiff base imine formation between the carbohydrate and poly(4-vinylaniline), FIG. 2(c). The NH₂ wag, bend and para substituted aromatic ring stretching (1500 cm⁻¹) are still visible as they remain present in the bulk of the nano-film.

The XPS surface elemental composition of the pulsed plasma deposited poly (4-vinylaniline) appeared to be in good agreement with the theoretical composition based on the monomer structure, Table 1. The absence of any Si(2 p) signal was indicative of a pinhole-free film.

TABLE 1
The XPS atomic composition of 4-vinylaniline plasma polymers.

| | % Carbon | % Oxygen |
|---|---|---|
| Theoretical | 88.8 | 11.2 |
| Pulsed Plasma Polymer | 87.8 ± 0.2 | 12.3 ± 0.2 |

Retention of the biological specificity of the carbohydrate upon immobilization onto the pulsed plasma poly(4-vinylaniline) was verified by fluorescence studies. This demonstrated selective binding of protein to regions of immobilized D-maltose, FIG. 2.

This example hence demonstrates the efficacy and utility of the method of the invention for producing highly functionalised surfaces bearing well-retained monomer amine functionality, and the opportunities offered by the further derivatisation of said amine functionality in fields such as glycomics and proteomics.

### EXAMPLE 2

Referring now to FIGS. 4-11 a further aspect of the invention is described. Plasma polymerization was carried out in a cylindrical glass reactor (4.5 cm diameter, 460 cm3 volume) located inside a Faraday cage and evacuated by a 30 L min-1 rotary pump via a liquid nitrogen cold trap (2×10−3 mbar base pressure and better than 1.2×10−9 mol s-1 leak rate). A copper coil (4 mm diameter, 10 turns, located 15 cm away from the precursor inlet) was connected to a 13.56 MHz radio frequency supply via an LC matching network. System pressure was monitored with a Pirani gauge. All fittings were grease free. During pulsed plasma deposition, the RF source was triggered by a signal generator, and the pulse shape monitored with an oscilloscope. Prior to each experiment the apparatus was scrubbed with detergent, rinsed with propan-2-ol, and oven dried. Further cleaning entailed running a 40 W continuous wave air plasma at 0.2 mbar pressure for 20 min. At this stage, each monomer was loaded into a sealable glass tube and further purified using multiple freeze-pump-thaw cycles. Then the substrate of interest was placed into the centre of the reactor, and the system evacuated to base pressure. For each functional monomer, a continuous flow of vapour was introduced via a fine needle control valve at a pressure of 0.2 mbar and 2.2×10−7 mol s-1 flow rate for 5 min prior to electrical discharge ignition. Optimum pulsed plasma duty cycle parameters for each precursor are listed in Table 2. Upon completion of deposition, the RF power source was switched off and the monomer was allowed to continue to purge though the system for a further 5 min prior to evacuation to base pressure and venting to atmosphere. Multiplex surface generation entailed the embossing a grid (2000 Mesh, Agar) at 400 MPa for 10 s onto pulsed plasma deposited poly(4-vinyalaniline), followed by the deposition of allylmercaptan and grid removal to leave 10 μm pulsed plasma deposited poly(allylmercaptan) squares separated via 2 μm pulsed plasma deposited poly(4-vinylaniline) bars.

Table 2 Optimum parameters for pulsed plasma polymerization of each monomer.

### Carbohydrate Functionalization

Carbohydrate microarrays were fabricated using a robotic microarrayer (Genetix Inc) equipped with 1 nL delivery micro-machined pins. Carbohydrate β-D-galacto-methanethiosulfonate or D-Maltose solutions were spotted onto pulsed plasma poly(allylmercaptan) or poly(4-vinylaniline) coated glass slides (18×18×0.17 mm, BDH), Table 3. Circular spots with diameters ranging from 100 to 125 μm could be routinely obtained. After spotting, the slides of immobilized carbohydrates β-D-galacto-methanethiosulfonate and D-Maltose were kept in a humidity chamber for 12 h at 32° C. and 36 h at 70° C., respectively. The slides were subsequently washed with CHES buffer, CHES buffer diluted to 50% v/v with de-ionized water, and twice with de-ionized water.

| | | | | Deposition |
|---|---|---|---|---|
| | Reactor | Pulse Duty Cycle/μs | | Rate/ |
| Precursor | Temp/° C. | Time On | Time Off | nm min-1 |
| Allylmercaptan | 22 | 100 | 4000 | 10 |
| (+80%, Sigma-Aldrich) | | | | |
| 4-vinylaniline | 40 | 100 | 4000 | 20 |
| (+97%, Sigma-Aldrich) | | | | |
| N-acryloylsarcosine | 50 | 20 | 5000 | 9 |
| methyl ester monomer | | | | |
| (+97%, Lancaster) | | | | |

TABLE 3
Carbohydrate solutions employed in this study.

| Carbohydrate | Concentration |
|---|---|
| β-D-galacto-methanethiosulfonate | 1 μm in 70 mM CHES buffer |
| (Ben Davis, Oxford University) | (+99%, Sigma Aldrich) |
| D-Maltose (+90%, Sigma-Aldrich) | 1 μm in Formamide |
| | (Sigma-Aldrich) |

Microarrays of carbohydrates β-D-galacto-methanethiosulfonate and D-Maltose were exposed to a complementary solution of Protein I (20 μg mL-1 in phosphate buffered saline) and Protein II (20 μg mL-1 in phosphate buffered saline) respectively for 60 min at room temperature followed by successive rinses in phosphate buffered saline, phosphate buffered saline diluted to 50% v/v with de-ionized water, and finally washed twice with de-ionized water, Table 4.

TABLE 4
Proteins and their associated fluorophores employed in this study.

| Protein | Fluorophore | Label |
|---|---|---|
| Peanut Agglutinin (Molecular Probes) | Alexa Fluor 488 | Protein I |
| Concanavalin A (Molecular Probes) | Alexa Fluor 647 | Protein II |

Stripping of bound carbohydrates β-D-galacto-methanethiosulfonate and D-Maltose from the pulsed plasma nanolayers was investigated by placing the chips in a boiling solution of 200 nM TrisCl pH 7.0, 0.03 M SSC and 0.1% (w/v) SDS for 10 min followed by re-immobilization by the above protocols.

Carbohydrate immobilization onto a multiplex surface formed via deposition though a grid entailed exposure to sequential solutions of carbohydrates β-D-galacto-methanethiosulfonate and D-Maltose for 12 h at 32° C. and 36 h at 70° C., respectively. The slides were subsequently washed with CHES buffer, CHES buffer diluted to 50% v/v with de-ionized water, and twice with de-ionized water. Carbohydrate functionalized multiplex surfaces were then exposed to a complementary solution of Protein I and II (20 μg mL-1 per protein in phosphate buffered saline) for 60 min at room temperature followed by successive rinses in phosphate buffered saline, phosphate buffered saline diluted to 50% v/v with de-ionized water, and finally washed twice with de-ionized water.

Carbohydrate immobilization via a molecular scratchcard entailed mounting a bilayer stack comprising 20 nm pulsed plasma deposited poly(N-acryloylsarcosine methyl ester) on top of a 300 nm pulsed plasma deposited binding layer, onto an atomic force microscope stage (Digital Instruments Nanoscope III control module, extender electronics, and signal access module, Santa Barbara, Calif.). The protein-resistant pulsed plasma poly(N-acryloylsarcosine methyl ester) top layer was scratched away using a tapping mode tip (Nanoprobe, spring constant 42-83 Nm-1) applied in contact mode. The movement of the tip in the x, y, and z plane was controlled by Veeco Nanolithography Software (Version 5.30r1). The patterned molecular scratchcards were immersed in a solution of carbohydrate β-D-galacto-methanethiosulfonate or D-Maltose for 12 h at 32° C. or 36 h at 70° C., respectively, followed by successive rinses in CHES buffered, CHES buffer diluted to 50% v/v with de-ionized water, and twice with de-ionized water. Functionalized molecular scratchcards were then exposed to a complementary solution of Protein I (20 μg mL-1 in phosphate buffered saline) or Protein II (20 μg mL-1 in phosphate buffered saline), respectively for 60 min at room temperature followed by successive rinses in phosphate buffered saline, phosphate buffered saline diluted to 50% v/v with de-ionized water, and finally washed twice with de-ionized water.

### Surface Characterization

X-ray photoelectron spectroscopy (XPS) was undertaken using an electron spectrometer (VG ESCALAB MK II) equipped with a non-monochromated Mg Kα1,2 X-ray source (1253.6 eV) and a concentric hemispherical analyser. Photo-emitted electrons were collected at a take-off angle of 30° from the substrate normal, with electron detection in the constant analyser energy mode (CAE, pass energy=20 eV). The XPS spectra were charge referenced to the C(1 s) peak at 285.0 eV and fitted with a linear background and equal full-width-at-half-maximum (FWHM) Gaussian components using Marquardt minimization computer software. Instrument sensitivity (multiplication) factors derived from chemical standards were taken as being C(1 s): S(2 p): O(1 s): N(1 s): equals 1.00: 0.52: 0.63: 0.45.

Fourier transform infrared (FTIR) analysis of the films was carried out using a Perkin-Elmer Spectrum One spectrometer equipped with a liquid nitrogen cooled MCT detector operating across the 700-4000 cm⁻¹ range. Reflection-absorption (RAIRS) measurements were performed using a variable angle accessory (Specac) set at 66° in conjunction with a KRS-5 polarizer fitted to remove the s-polarized component. All spectra were averaged over 516 scans at a resolution of 1 cm⁻¹.

Contact angle analysis of the plasma-deposited films was carried out with a video capture system (ASE Products, model VCA2500XE) using 2.0 μL droplets of de-ionized water.

Film thickness measurements were carried out using an nkd-6000 spectrophotometer (Aquila Instruments Ltd). Transmittance-reflectance curves (over the 350-1000 nm wavelength range) were fitted to the Cauchy model for dielectric materials using a modified Levenburg-Marquardt method.

AFM micrographs of each surface were acquired in tapping mode operating in air at room temperature (Digital Instruments Nanoscope III control module, extender electronics, and signal access module, Santa Barbara, Calif.).

Fluorescence microscopy was performed using an Olympus IX-70 system (DeltaVision RT, Applied Precision, WA). Image data was collected using excitation wavelengths at 490 nm.

1. A method of applying an amine containing layer to a substrate, said method comprising subjecting said substrate to a plasma discharge in the presence of a compound of general formula (I) 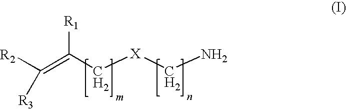
where X is an optionally substituted straight or branched alkylene chain(s) or aryl group(s); R¹, R² or R³ are optionally substituted hydrocarbyl or heterocyclic groups; and m and n are integers of 0 or greater value.

2. A method according to claim 1 wherein the compound of formula (I) is 4-vinylaniline.

3. A method according to claim 1 wherein the plasma discharge is pulsed.

4. (canceled)

5. (canceled)

6. A method according to claim 3 wherein the pulsed plasma discharge is applied such that the pulsing regime changes throughout the course of a single layer deposition.

7. A method according to claim 1 wherein the plasma discharge contains the compound of formula (I) in the absence of any other material.

8. A method according to claim 1 characterized in that additional materials to the compound of formula (I) are added to the plasma discharge.

9. A method according to claim 8 characterized in that said additional materials are substantially inert and are not incorporated within the reactive amine containing product layer.

10. A method according to claim 8 characterized in that said additional materials are non-inert and possess the capability to modify and/or be incorporated into the reactive amine containing product layer.

11. A method according to claim 10 characterized in that the use of said non-inert additional materials results in a copolymer layer that contains reactive amine functionality.

12. A method according to claim 1 characterized in that the introduction of the compound of formula (I) and/or any additional materials into the plasma discharge is pulsed.

13. A method according to claim 1 characterized in that the compound of formula (I) and/or any additional materials are introduced into the plasma discharge in the form of atomised droplets.

14. (canceled)

15. A method according to claim 1 characterized in that the plasma deposition chamber is heated.

16. (canceled)

17. A method according to any one of claims 1-3, 6-13, and 15 which further comprises the step of derivatization or reaction of the amine groups after the deposition of the layer.

18. A method according to claim 17 wherein the step of derivatization is used for quatarnization of the amine groups.

19. A method according to claim 17 wherein the step of derivatization is used for electroless metal deposition.

20-71. (canceled)
